(19) United States
(12) Patent Application Publication
(10) Pub. No.: US 2024/0166570 A1
(43) Pub. Date: May 23, 2024

(54) PROCESS FOR PRODUCING AMMONIUM THIOSULFATE FROM ANAEROBIC DIGESTATE

(71) Applicant: ThioSolv, LLC, Largo, FL (US)

(72) Inventors: Michael J. Ray, Clearwater, FL (US); Michael F. Ray, Clearwater, FL (US); Matthew F. Ray, Clearwater, FL (US)

(21) Appl. No.: 18/515,447

(22) Filed: Nov. 21, 2023

Related U.S. Application Data
(60) Provisional application No. 63/384,738, filed on Nov. 22, 2022.

(51) Int. Cl. C05C 3/00; B01D 53/52; B01D 53/78; C01B 17/64; C05G 3/40

(52) U.S. Cl. CPC C05C 3/00; B01D 53/52; B01D 53/78; C01B 17/64; C05G 3/40; B01D 2257/304; B01D 2258/05

(57) ABSTRACT

A process for producing ammonium thiosulfate from anaerobic digestate. The process involves injecting sulfur dioxide or ammonium bisulfite into a column containing liquid digestate and biogas to produce a sulfite solution. The sulfite solution further reacts with hydrogen sulfide entrained in the biogas and the digestate to produce commercially desirable ammonium thiosulfate and sweet biogas.

### CROSS REFERENCE TO RELATED PATENTS

This application claims priority from U.S. Provisional Patent Application No. 63/384,738 file on Nov. 22, 2022, the entire disclosure of which is part of the disclosure of the present application and is hereby incorporated by reference in its entirety.

### FIELD OF THE INVENTION

The present invention relates to a process for producing ammonium thiosulfate from anaerobic digestate. Specifically, the present invention removes hydrogen sulfide from anaerobic digestate and biogas while producing ammonium thiosulfate, a high value-added agricultural product.

### BACKGROUND

In an effort to reduce the greenhouse gas emissions that originate from animal excrement and organic waste, anaerobic digesters are commonly employed to produce a natural gas that can be used as a fuel source. This natural gas, commonly referred to as biogas, is produced by microorganisms during the anaerobic digestion of organic matter. The gas typically contains, but is not limited to, carbon dioxide, methane, ammonia, and hydrogen sulfide. However, hydrogen sulfide is a highly toxic and corrosive gas that can be lethal to humans at low exposure limits. Biogas with higher amounts of hydrogen sulfide than is permitted by environmental regulators must be removed by downstream processes. Similarly, ammonia is harmful at elevated levels and requires additional processing or removal prior to the recycling or storage of the anaerobic digestate.

Depending on the pH of the anaerobic digestate, ammonia or hydrogen sulfide may be entrained in the solution. When used as a fertilizer, these gases may be uncontrollably released when applied to the soil, during blending with other components before application to the soil, upon contact with low pH materials in the soil, or during mixing with more acidic solutions. The uncontrolled release of ammonia and hydrogen sulfide may cause serious harm to farmers, agricultural workers, or other individuals in the vicinity. Conventionally, ammonia removal from digestate involves using air or steam. However, for small streams of digestate, this may not be a practical solution as the capital and operational expenditures may be large. Especially in the case of small digesters, it may not always be economical to produce commercial fertilizer, so the digestate may be sent to a lagoon and then pumped back onto land. Depending on the pH of the soil, this may cause a release of ammonia or hydrogen sulfide. Therefore, there is a need for a process that removes ammonia and hydrogen sulfide from anaerobic digestate that is economical and also produces a safe and marketable product.

### SUMMARY OF THE INVENTION

According to one or more embodiments, a process for producing ammonium thiosulfate (ATS) from anaerobic digestate and biogas involves reacting ammonia and hydrogen sulfide with sulfur dioxide. ATS can be beneficially used as a slow-release agricultural fertilizer. The process further involves substantially removing hydrogen sulfide and ammonia from the biogas. In one or more embodiments, the sulfur dioxide is replaced by ammonium bisulfite.

In one embodiment, a process for producing ammonium thiosulfate from anaerobic digestate involves: routing a stream of the anaerobic digestate into a column with a circulating aqueous solution, wherein the anaerobic digestate stream comprises hydrogen sulfide; introducing a stream of sulfur dioxide into the column, wherein the sulfur dioxide reacts with the anaerobic digestate to produce an ammonium sulfite and/or ammonium bisulfite solution; routing a stream of biogas into the column, wherein the biogas comprises hydrogen sulfide; and contacting the hydrogen sulfide in the anaerobic digestate and the biogas stream with the ammonium sulfite and/or ammonium bisulfite solution to produce an effluent stream containing aqueous ammonium thiosulfate. The column comprises a plurality contact zones. The anaerobic digestate can be filtered prior to introduction into the column to substantially remove entrained solids and heavy metals.

The process further involves introducing an optional ammonia stream into the column. The ammonia stream can be adjusted to maintain the pH in the column. The pH can be balanced to a range of 5.5 to 8.5.

The biogas is produced from an anaerobic digestion reaction. The biogas comprises methane, carbon dioxide, hydrogen sulfide, and ammonia. The process further comprises substantially scrubbing the hydrogen sulfide from the biogas. The scrubbed biogas/sweet biogas exits from the top of the column while the aqueous ammonium thiosulfate exits from the bottom of the column.

The sulfur dioxide can be introduced into the column at a first feed point, and the biogas can be routed to the column at a second feed point. The second feed point can be located below the first feed point. The sulfur dioxide stream can be substantially mixed with the anaerobic digestate prior to introduction to the column.

A portion of the aqueous ammonium thiosulfate can be recirculated back through the column depending on the concentration of the hydrogen sulfide in the biogas.

In another embodiment, instead of sulfur dioxide, an ammonium bisulfite solution can be introduced to the digestate. Hydrogen sulfide in the anaerobic digestate and a biogas stream is contacted with the ammonium bisulfite solution to produce an effluent stream containing aqueous ammonium thiosulfate. Optionally, an ammonia stream can also be introduced into the column to maintain the pH in the column and balance stoichiometry. The pH is balanced to a range of 6.0 to 7.5. A portion of the aqueous ammonium thiosulfate can be recirculated back through the column. The process further comprises substantially scrubbing the hydrogen sulfide from the biogas. The scrubbed biogas/sweet biogas exits from the top of the column while the aqueous ammonium thiosulfate exits from the bottom of the column.

Additional features and advantages of the invention will be described hereinafter which form the subject of the claims of the invention. It should be appreciated by those skilled in the art that the conception and the specific embodiment disclosed might be readily utilized as a basis for modifying or redesigning the structures for carrying out the same purposes as the invention. The foregoing has outlined rather broadly several aspects of the present invention in order that the detailed description of the invention that follows may be better understood.

### BRIEF DESCRIPTION OF THE DRAWINGS

The invention will be described in detail below with reference to the attached drawings which describe or relate to an apparatus and methods for the present invention.

FIG. 1 illustrates a schematic diagram of an exemplary system for reacting the ammonia and hydrogen sulfide from anaerobic digestate to create ammonium thiosulfate.

FIG. 2 illustrates a schematic diagram of an alternative system for reacting the ammonia and hydrogen sulfide from anaerobic digestate to create ammonium thiosulfate.

### DETAILED DESCRIPTION

Depending on the context, all references below to the “invention” may in some cases refer to certain specific embodiments only. In other cases, it will be recognized that references to the “invention” will refer to subject matter recited in one or more, but not necessarily all, of the claims.

When describing a range of pHs, concentrations and the like, it is the Applicant's intent to disclose every individual number that such a range could reasonably encompass, for example, every individual number that has at least one more significant figure than in the disclosed end points of the range. As an example, when referring to a pH as between about 4.5 and 8.5, it is intended to disclose that the pH can be 4.5, 8.5 or any value between these values, including any subranges or combinations of subranges encompassed in this broader range. Applicant's intent is that these two methods of describing the range are interchangeable. Moreover, when a range of values is disclosed or claimed, Applicant also intends for the disclosure of a range to reflect, and be interchangeable with, disclosing any and all sub-ranges and combinations of sub-ranges encompassed therein. Accordingly, Applicant reserves the right to proviso out or exclude any individual members of any such group, including any sub-ranges or combinations of sub-ranges within the group, or any selection, feature, or aspect that can be claimed, if for any reason Applicant chooses to claim less than the full measure of the disclosure, for example, to account for a reference that Applicant may be unaware of at the time of the filing of the application. In particular, the ranges set forth herein include their endpoints unless expressly stated otherwise.

The term “about” means that pH and other parameters and characteristics are not and need not be exact, but may be approximate and/or larger or smaller, as desired, reflecting tolerances, conversion factors, rounding off, measurement error and the like, and other factors known to those of skill in the art. An amount, size, formulation, parameter or other quantity or characteristic is “about” or “approximate” whether or not expressly stated to be such. Whether or not modified by the term “about”, the claims include equivalents to the values stated therein.

Furthermore, the particular illustrative embodiments disclosed herein may be altered or modified and all such variations are considered within the scope and spirit of the present invention. While process is described in terms of “comprising,” “containing,” or “including” various devices/components or steps, it is understood that the process also can “consist essentially of” or “consist of” the various components and steps.

As used herein, the terms “column” and “contact zone” can include any combination of towers, columns, trays, vessels, pumps, valves, control systems, and any other equipment known in the art useful in contacting liquids and gases.

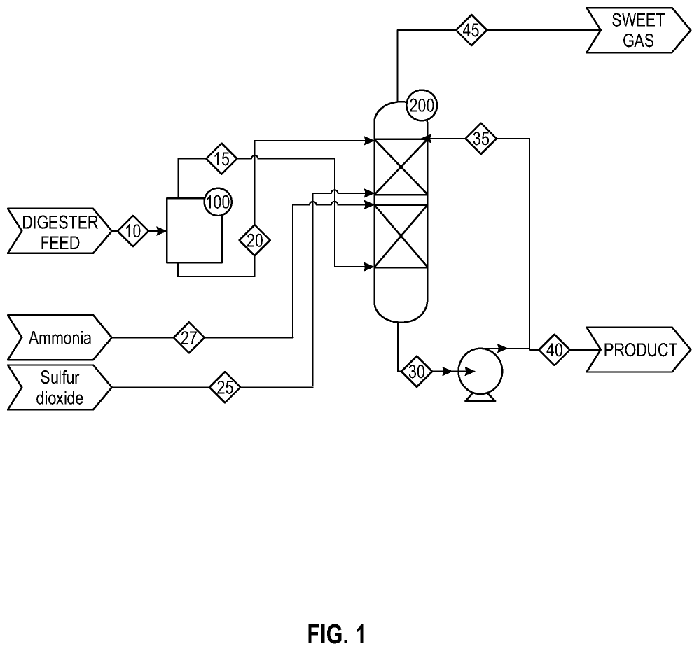

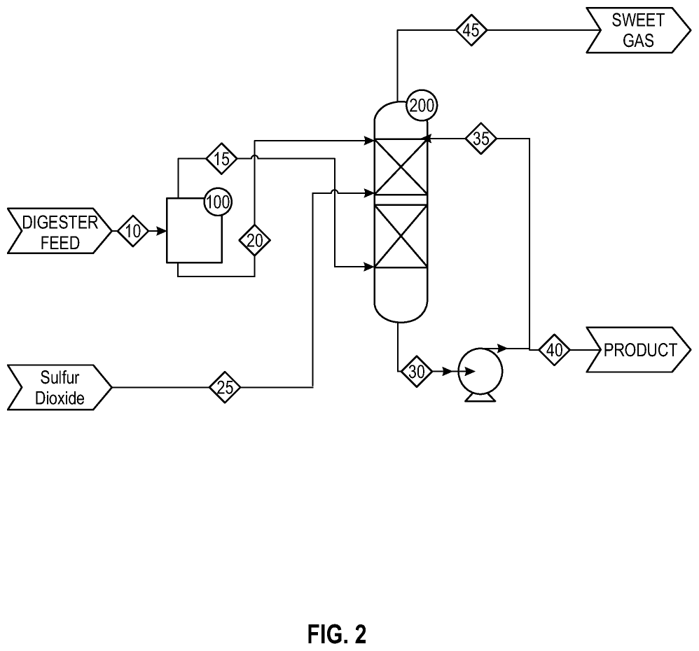

The present invention relates to systems and processes for removing hydrogen sulfide and ammonia from a liquid or gas stream. In particular, the present invention relates to a system for removing hydrogen sulfide and ammonia from anaerobic digestate and biogas to produce an agricultural fertilizer, such as ammonium thiosulfate (ATS). Exemplary embodiments of the system are depicted in FIG. 1 and FIG. 2.

In one or more embodiments, anaerobic digestate from a digester is substantially contacted with sulfur dioxide at the top of a column. The sulfur dioxide reacts with ammonia and water in the digestate to produce a mixture of ammonium bisulfite (ABS) and/or ammonium sulfite in the aqueous solution. The sulfite/bisulfite solution further reacts with entrained hydrogen sulfide in the digestate to produce ammonium thiosulfate (ATS). Critically, the flow of sulfur dioxide is controlled to maintain the pH of the solution to be between in a range that substantially captures hydrogen sulfide.

Biogas comprising carbon dioxide, methane, ammonia, and hydrogen sulfide from an anaerobic digester is added directly to the bottom of a column. The biogas encounters the aqueous ABS/sulfite solution in one or more contact zones in the column whereupon hydrogen sulfide contained in the biogas reacts to form ammonium thiosulfate. Advantageously, the ammonium thiosulfate stabilizes the remaining sulfite and bisulfite anions to inhibit further oxidation.

Excess sulfur dioxide is added to the anaerobic digestate to produce excess sulfite and bisulfite anions. The additional sulfite anions ensure that hydrogen sulfide is substantially removed from the biogas when they are mixed. Similarly, excess ammonia can be added to the anaerobic digestate to balance the pH of the solution or to increase the amount of ATS in circulating solution.

The ammonium thiosulfate solution exits the bottom of the column and is taken as a high value product or is recycled back to the top of the column to further react with biogas and anaerobic digestate. Continued recycling of the solution can be used to increase the amount of ATS in the final product. Importantly, the biogas exiting the top of the column can be substantially free of ammonia and hydrogen sulfide while the remaining components, carbon dioxide and methane, are unreacted.

As illustrated in FIG. 1, a first process stream 10 containing digester feed can be introduced to Anaerobic Digester 100. Liquid digestate from the Anaerobic Digester 100 can be transferred via process stream 20 to a top of Column 200. In one or more embodiments of the process, the liquid digestate in stream 20 can be filtered to remove organic compounds or other impurities with the exception of the entrained ammonia and hydrogen sulfide. The filtering process can be accomplished with any filter or media known in the art that substantially removes insoluble solids from a liquid stream. The filtering of stream 20 further removes heavy metals, if present, prior to downstream processing.

A process stream 25, a liquid or gas stream containing sulfur dioxide, substantially mixes with the liquid digestate in one or more contact zones within Column 200. In one or more embodiments of the invention, a device such as a Venturi contactor can be used to substantially mix the digestate liquid and the sulfur dioxide gas prior to entering Column 200. According to another embodiment, the digestate liquid and the sulfur dioxide gas can be mixed with any static mixer or other mixer known in the art. Ammonia contained within the liquid digestate reacts with the sulfur dioxide to create ammonium bisulfite and/or ammonium sulfite. The sulfite/bisulfite solution can further react with entrained hydrogen sulfide to produce ammonium thiosulfate. Thus, the embodiments of the invention facilitate removal of ammonia and hydrogen sulfide from the digestate.

The sulfur dioxide stream 25 can be obtained from the oxidation of sulfur on site, or it can be a purchased stream of sulfur dioxide. In another embodiment, an ammonium bisulfite solution can be utilized in place of sulfur dioxide gas as process stream 25. The bisulfite solution is preferable for high concentrations of hydrogen sulfide entrained in the biogas wherein the stoichiometric ratio to sulfur to ammonia is also high. The bisulfite solution can be introduced directly to the liquid digestate prior to entering the contact zone with the biogas.

In one or more embodiments, a process stream 27 comprising aqueous or anhydrous ammonia, can be optionally added to one or more contact zones within Column 200. The ammonia stream 27 can be utilized to adjust the pH or to balance the stoichiometry of the conversion of hydrogen sulfide in the system to ATS. It is understandable that the number of contact zones in Column 200 and the point at which process stream 27 is applied to the column is dependent on the phase of the ammonia source.

Biogas generated during digestion in Anaerobic Digester 100 proceeds through process stream 15 to Column 200. In one or more embodiments, the sulfur dioxide stream enters Column 200 above the biogas feed point allowing the digestate to contact the biogas. In one or more embodiments, the biogas is passed through the bottom of Column 200 where it flows upwards and contacts the liquid digestate. Excess sulfur dioxide gas added to the digestate in Column 200 produces excess sulfite anions in solution. The sulfites will subsequently react with hydrogen sulfide contained in the biogas to produce ammonium thiosulfate.

According to an embodiment, the pH in Column 200 is maintained between 5.5 and 8.5, and preferably between 6.0 and 7.5, by controlling the flow of sulfur dioxide and ammonia. It should be easily understandable to persons skilled in the art that the amount of sulfur dioxide and ammonia added, and the resulting pH can be optimized for the capture of hydrogen sulfide from the biogas and anaerobic digestate.

Biogas exiting from the top of Column 200 via stream 45 is substantially free of hydrogen sulfide (sweet biogas). A liquid product containing ammonium thiosulfate leaves the bottom of Column 200 through process stream 30. Depending on the concentration of hydrogen sulfide in the biogas, the liquid product may be recirculated or recycled via stream 35 back to the top of Column 200. Otherwise, the liquid product can be removed as process stream 40.

It should be apparent that the process of removing hydrogen sulfide from the biogas and the digestate can be optimized by creating one or more contact zones in Column 200 from one or more feed points. Likewise, the number of contact zones and feed points can be adjusted for gaseous or aqueous inputs of sulfur dioxide and ammonia.

As illustrated in FIG. 2, an alternative embodiment of the process for producing ammonium thiosulfate from anaerobic digestate is shown. This is similar to the embodiment of FIG. 1 but does not include an additional ammonia process stream.

Thus, the embodiments of the present invention react the ammonia contained in the digestate to a bisulfite or ATS mixture, lower the vapor pressure of the ammonia in the liquid, and facilitates scrubbing the hydrogen sulfide out of the biogas. ATS is considered as a slow-release fertilizer that is a good source of sulfur. ATS inhibits bacteria in the soil from conversion of ammonia to ammonium nitrate which can end up in ground water and maintains the usable form of sulfur in the root zone longer.

The one or more embodiments of the present invention do not involve the separation of ammonia from the digestate. Instead, the ammonia present in the digestate is reacted with sulfur dioxide for conversion to ammonium sulfite, and a portion of this can further react with hydrogen sulfide in the digestate and biogas to produce ATS.

The one or more embodiments of the present invention can be used to produce useful fertilizer (ATS) from small streams of digestate. Conventionally, fertilizers cannot be produced from such small streams since the capital and operational expenditures are not justifiable. However, in the present invention, sulfur dioxide can be directly contacted with the digestate for ammonia conversion to ammonium sulfite and a portion of that further reacts with hydrogen sulfide to produce ATS, which can be used for agricultural purposes.

Advantageously, according to the one or more embodiments of the present invention, additional treatment is not required to remove hydrogen sulfide from the biogas to meet most pipeline specifications and no additional waste material is created that requires disposal.

The description presents several preferred embodiments of the present invention in sufficient detail such that those skilled in the art can make and use the invention. As used herein, the words “comprise,” “have,” “include,” and all grammatical variations thereof are each intended to have an open, non-limiting meaning that does not exclude additional elements or steps.

Therefore, the present invention is well adapted to attain the ends and advantages mentioned as well as those that are inherent therein. The one or more embodiments disclosed above are illustrative only, as the present invention may be modified and practiced in different but equivalent manners apparent to those skilled in the art having the benefit of the teachings herein. It is, therefore, evident that the particular illustrative embodiments disclosed above may be altered or modified and all such variations are considered within the scope and spirit of the present invention.

1. A process for producing ammonium thiosulfate from anaerobic digestate, comprising:
routing a stream of the anaerobic digestate into a column with a circulating aqueous solution, wherein the anaerobic digestate stream comprises hydrogen sulfide;
introducing a stream of sulfur dioxide into the column, wherein the sulfur dioxide reacts with the anaerobic digestate to produce an ammonium sulfite and/or ammonium bisulfite solution;
routing a stream of biogas into the column, wherein the biogas comprises hydrogen sulfide; and
contacting the hydrogen sulfide in the anaerobic digestate and the biogas stream with the ammonium sulfite and/or ammonium bisulfite solution to produce an effluent stream containing aqueous ammonium thiosulfate.

2. The process according to claim 1, further comprising introducing an ammonia stream into the column.

3. The process according to claim 2, wherein the ammonia stream is adjusted to balance the pH in the column.

4. The process according to claim 3, wherein the pH is balanced to a range of 5.5 to 8.5.

5. The process according to claim 4, wherein the pH is balanced to a range of 6.0 to 7.5.

6. The process according to claim 1, further comprising filtering the anaerobic digestate prior to introduction into the column to substantially remove entrained solids and heavy metals.

7. The process according to claim 1, wherein the biogas is produced from an anaerobic digestion reaction.

8. The process according to claim 7, wherein the biogas comprises methane, carbon dioxide, hydrogen sulfide, and ammonia.

9. The process according to claim 1, wherein the column comprises a plurality contact zones.

10. The process according to claim 2, wherein the sulfur dioxide is introduced into the column at a first feed point, and wherein the biogas is routed to the column at a second feed point, and wherein the second feed point is below the first feed point.

11. The process according to claim 1, wherein the sulfur dioxide stream is substantially mixed with the anaerobic digestate prior to introduction to the column.

12. The process according to claim 1, wherein a portion of the aqueous ammonium thiosulfate is recirculated back through the column.

13. The process according to claim 1, further comprising substantially scrubbing the hydrogen sulfide from the biogas.

14. A process for producing ammonium thiosulfate from anaerobic digestate, comprising:
routing a stream of the anaerobic digestate into a column with a circulating aqueous solution, wherein the anaerobic digestate stream comprises hydrogen sulfide;
introducing an ammonium bisulfite solution to the digestate;
routing a stream of biogas into the column, wherein the biogas comprises hydrogen sulfide; and
contacting the hydrogen sulfide in the anaerobic digestate and the biogas stream with the ammonium bisulfite solution to produce an effluent stream containing aqueous ammonium thiosulfate.

15. The process according to claim 14, further comprising introducing an ammonia stream into the column.

16. The process according to claim 15, wherein the ammonia stream is adjusted to maintain the pH in the column and balance stoichiometry.

17. The process according to claim 16, wherein the pH is balanced to a range of 6.0 to 7.5.

18. The process according to claim 14, wherein a portion of the aqueous ammonium thiosulfate is recirculated back through the column.

19. The process according to claim 14, further comprising substantially scrubbing the hydrogen sulfide from the biogas.

20. The process according to claim 19, wherein the scrubbed biogas exits from the top of the column while the aqueous ammonium thiosulfate exits from the bottom of the column.
